(19) United States
(12) Patent Application Publication
(10) Pub. No.: US 2004/0095021 A1
(43) Pub. Date: May 20, 2004

(54) Power distributor

(75) Inventors: Harry Frank Fogleman, Rancho Santa Fe, CA (US); Kris Land, Poway, CA (US)

Correspondence Address: HOGAN & HARTSON L.L.P., 500 S. GRAND AVENUE, SUITE 1900, LOS ANGELES, CA, 90071-2611, US

(73) Assignee: INOSTOR CORPORATION

(21) Appl. No.: 10/295,371

(22) Filed: Nov. 15, 2002

(51) Int. Cl. H02J 1/10

(52) U.S. Cl. 307/52

(57) ABSTRACT

A power distributor in a redundant power supply apparatus employing one or more metal-oxide-semiconductor field effect transistors (MOSFETs). One or more power supplies are connected to a load, each power supply being connected to the load via one or more MOSFETs connected in parallel with each other. The MOSFETs are connected in a reversed direction where the sources are connected to the power supplies and the drains are connected to the load. Each power supply is provided with an associated control circuit which includes a comparator connected to the power supply voltage and to the load voltage, the control circuit generating a gate control voltage for the MOSFETs to turn the MOSFETs on and off and also to provide minor resistive changes via the control circuit that allow dynamic load balancing of each power supply with respect of the load. Used in a redundant power supply configuration, this circuit evenly distributes the load among the plurality of normally functioning power supplies, and in the case of failure of one or more power supplies, shifts the load to the remaining power supplies.

### BACKGROUND OF THE INVENTION

1. Field of the Invention

This invention relates to a redundant power supply apparatus, and in particular, it relates to a power distributor in a redundant power supply of two or more power supplies and an apparatus employing two or more field effect transistors (FETs).

2. Description of the Related Art

In high-availability computing and other applications, power supply systems utilizing dual or multiple power supplies (such as batteries) are desirable because of their failover security. In addition, such a power supply system results in a longer expected lifetime of the individual power supplies because in normal use each power supply typically runs at less than 50% capacity. In such a power supply system, a control circuit is desired that burdens each power supply with substantially the same amperage in normal use, that does not fluctuate its usage division at frequencies likely to disturb the power supply system hardware, and that responds to a failure of one or more power supplies by shifting the entire burden to the other power supply or power supplies.

A conventional device that achieves some of the above goals uses ORing diodes. As shown in FIG. 3, a plurality of diodes (such as Schottky diodes) 33a, 33b are connected to a load 32 in an “ORing” configuration, each diode being connected in series to a power supply 31a, 31b. This configuration permits each power supply to contribute to load bearing, but prevents backflow of current that would otherwise occur when one power supply fails and the others continue to function.

In such a device using the ORing diodes, each diode exhibits a voltage drop which is a function of the amperage and temperature. This results in inefficiency due to the voltage drop across the diode, heat generation, and decay of the diode itself, which has a finite lifetime dependent on the energy waste produced by this factor. In addition, the conventional ORing diode arrangement tends to display a positive feedback when a power supply is about to fail. Typically, such a power supply will exhibit a “short-like” behavior, which results in the associated diode assigning the failing power supply more than its share of the burden. This overload, in turn, accelerates the failure process.

A power supply device using a power FET is described in U.S. Pat. No. 5,811,889 to Massie. This device includes a transformer for providing an AC voltage, a rectify and filter circuit connected to the AC voltage for providing a DC voltage at the source of a power FET which generates an output voltage at its drain, and a start-up circuit and a shut-down circuit connected to the AC voltage for controlling the gate voltage of the FET.

### SUMMARY OF THE INVENTION

The present invention is directed to a power supply apparatus that substantially obviates one or more of the problems due to limitations and disadvantages of the related art.

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

The invention provides a circuit adapted to be connected between a plurality of power supplies and a load. The circuit includes a plurality of metal-oxide-semiconductor field effect transistors (MOSFETs) each having a source connected to a power supply voltage provided by a power supply, a drain connected to the load to provide a load voltage, and a gate; and a plurality of control circuits each having a first and a second input connected to the source and the drain of one or more MOSFETs, respectively, and an output connected to the gate of the corresponding MOSFETs for applying a control voltage to turn the MOSFETs on and off, the control voltage being generated based on voltage signals at the first and the second input.

In another aspect, the present invention provides a method of providing power from a plurality of power supplies to a load. The method includes connecting one or more metal-oxide-semiconductor field effect transistors (MOSFET) between each power supply and the load, wherein a source of each MOSFET is connected to a corresponding power supply and a drain of the MOSFET is connected to the load; and controlling the conductivity between the source and drain of each MOSFET by generating a control voltage in response to a voltage signal at the source and a voltage signal at the drain of the corresponding MOSFET and applying the control voltage to a gate of the MOSFET to turn the MOSFET on and off.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a circuit diagram showing a power supply system using a plurality of MOSFETs each connected between a power supply and a load according to an embodiment of the present invention.

FIG. 2 is a circuit diagram showing a power supply system using a plurality of MOSFETs connected in parallel between power supply and a load according to another embodiment of the present invention.

FIG. 3 is a circuit diagram showing a power supply system using ORing diodes to supply power from a plurality of power supplies to a load.

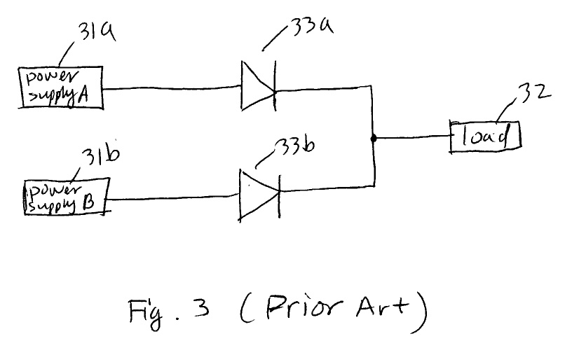

### DETAILED DESCRIPTION OF THE PREFERRED EMBODIMENTS

Embodiments of the present invention take advantage of the fact that an n-channel metal-oxide-semiconductor field effect transistor (MOSFET) can function as a “reverse body diode” when the source of the MOSFET is connected to a higher potential (such as a power supply) and the drain is connected to a lower potential (such as a load). The current passing through such a reverse body diode behaves as though it is under a resistive load, somewhat similar to the diode in the ORing diode system, but with a lower resistance value, making the device more efficient than the ORing diode. The voltage drop of the MOSFET is typically more than an order of magnitude less than that of the standard ORing diode. In addition, the leakage current in the MOSFET is also lower than that in a Schottky diode. For example, the relative leakage for comparably rated devices, such as a 50 Amp MOSFET and a 50 Amp Schottky diode, may be up to roughly 1000 times greater for the Schottky diode. In addition, when sufficient gate voltage is applied, the voltage drop of the reverse MOSFET may be controlled by the gate voltage which provides minor resistive changes via the control circuit that allows dynamic load balancing of each power supply with respect of the load. The dynamic nature of the gate voltage control allows for a substantially equal load balancing among all power supplies.

A power distributor according to embodiments of the present invention uses one or more reverse body diode MOSFETs connected between each of a plurality of power supplies and a load. The output of each power supply is monitored by a control circuit which in turn controls the MOSFET(s) connected to the power supply.

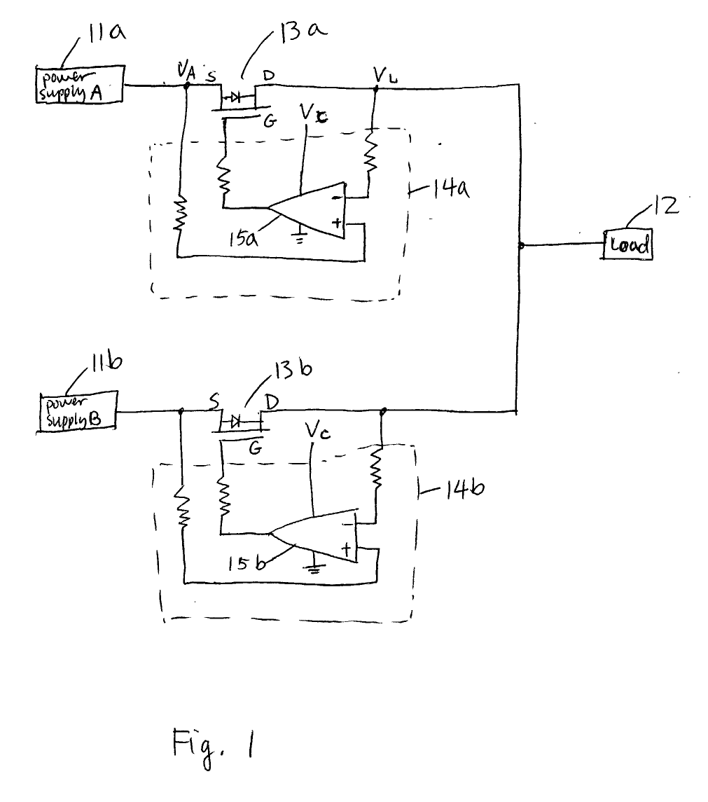

In a first embodiment shown in FIG. 1, a plurality of power supplies 11a, 11b, . . . are arranged to supply power to a load 12, with a plurality of MOSFETs 13a, 13b, . . . each connected in a reverse direction between a respective power supply and the load. Each MOSFET is provided with a control circuit 14a, 14b, . . . for turning on and off the current path of the MOSFET. The circuit arrangement and operation of the first power supply 11a are described in detail below, with the understanding that the circuits with respect to other power supplies 11b, . . . are similarly provided.

The MOSFET 13a is connected at its source S to the voltage V_{A} provided by the power supply 11a, and at its drain D to the load 12 to output a load voltage V_{L}. The MOSFET has an intrinsic body diode that is forward biased between the source and the drain. The MOSFET 13a in this embodiment is an n-channel device, but a p-channel device may also be used with appropriate circuit adjustments. The control circuit 14a includes a comparator 15a having a non-inverting input terminal connected to the power supply voltage V_{A} and an inverting input terminal connected to the load voltage V_{L}. A signal generated at the output of the comparator 15a is applied to the gate G of the MOSFET 13a. The comparator 15a is supplied with a drive voltage (comparator supply voltage) V_{C} that is higher than V_{A}+V_{R}, or the sum of power supply voltage V_{A} and the threshold gate-to-source voltage V_{R} that is needed to turn on the MOSFET 13a. The voltage V_{C} is preferably supplied at low amperage and low power by a charge pump, a housekeeping source or a similar device using the load voltage or the power supply voltages. Alternatively, the voltage V_{C} may be supplied by an appropriate external voltage source. The “housekeeping” voltage source may be derived from a secondary winding that produces a sufficiently high voltage. A charge pump is a device that essentially doubles the available voltage. The charge pump is generally preferred for higher load voltages (5 volts and higher), while the housekeeping technique is generally preferred for lower load voltages. The charge pump preferably operates from a voltage derived from the source or load voltage and typically generates a voltage approximately double the source voltage. In one embodiment, a charge pump, a comparator with a positive feedback resistor and an N-Channel MOSFET are integrated onto one die.

In normal operation, the power supply voltage V_{A} is higher than the load voltage V_{L}, the current path of the MOSFET 13a is turned ON and current flows from the power supply 11a to the load 12. The reverse body diode of the MOSFET 13a is shorted, and the MOSFET behaves like a resistive load. The voltage drop across the source and drain of MOSFET 13a is determined by the current flowing through the MOSFET and the “ON” resistance R_{DSon} of the MOSFET. The comparator 15a monitors the voltage across the MOSFET 13a and outputs a control voltage for the gate G of the MOSFET. The comparator has a resistor from the comparator output to its non-inverting input to provide speed-up and hysterisis for optimum performance in this application. In normal operation when the power supply voltage V_{A} is higher than the load voltage V_{L}, the comparator applies a positive control voltage that is greater than the voltage V_{A}+V_{R} to the gate G of the MOSFET 13a to maintain the “ON” state of the MOSFET.

During normal operation, because each of the plurality of power supplies 11a, 11b, . . . is connected to the load via a resistance R_{DSon} of the respective MOSFET 13a, 13b, . . . , the current provided by each power supply is regulated by the relative supply voltages of the plurality of power supplies 11a, 11b, . . . This ensures a more even distribution of burden among the power supplies as long as all power supplies are normally functioning, reduces fluctuation, and when one power supply begins to weaken, minimizes the positive feedback as often occurs in conventional circuits employing ORing diodes. As a result, the power supply life is prolonged.

When a power supply, e.g. 11a, begins to fail, the power supply voltage V_{A} drops to a level below the normal power supply voltage, while the load voltage V_{L} is substantially unchanged because other power supplies continue to supply power to the load 12. As a result, the voltage V_{A} becomes lower than the voltage V_{L}, and the comparator 15a outputs a negative control voltage to the gate G of the MOSFET 13a. This turns OFF the current path of the MOSFET 13a, thereby preventing a backflow current from the load 12 to the failed power supply 11a.

As compared to conventional ORing diodes, the power distributor circuit of FIG. 1 is more efficient with less voltage drop and power loss. For example, in one embodiment, the resistance of the reverse body diode of a MOSFET may be approximately 5 mOhm at a current of 10 amps with a voltage drop of 0.05 volts, while the resistance of a typical Schottky rectifier used in an ORing diode may be 50 mOhm at the same current level with a voltage drop of 0.5 volt. If each power supply supplies 10 amps of current, the power loss in each diode is 5W, while the power loss in each MOSFET is 0.5W.

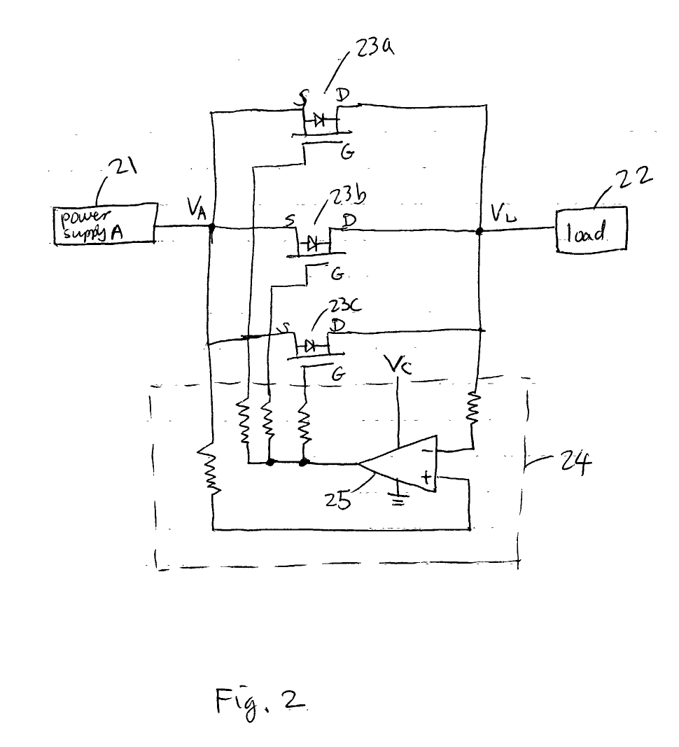

FIG. 2 illustrates another embodiment of the present invention, in which a plurality of MOSFETs 23a, 23b, . . . are connected in parallel with each other between a power supply 21 and a load 22. The source S of each MOSFET 23a, 23b, . . . is connected to the power supply voltage V_{A} of the power supply 21, and the drain D of each MOSFET is connected to the load 12 to provide a load voltage V_{L}. The MOSFET 23a, 23b . . . in this embodiment are n-channel devices, but p-channel devices may also be used with appropriate circuit adjustments. A control circuit 24 provides a gate voltage to each of the MOSFETs 23a, 23b . . . for turning ON and OFF the current path of the MOSFET. The control circuit includes a comparator 25 which is connected to the power supply voltage V_{A} at a non-inverting input terminal and to the load voltage V_{L} at an inverting input terminal, and which outputs a control voltage for the gate G of each of the MOSFETs. The comparator 25 is supplied with a drive voltage V_{C} that is higher than V_{A}+V_{R}, or the sum of V_{A} and the threshold gate-to-source voltage V_{R} that is needed to turn on the MOSFETs. Although not shown in FIG. 2, a plurality of redundant power supplies are provided, each connected to the load 22 via one or more parallel-connected MOSFETs and a control circuit in a configuration similar to that shown in FIG. 2 for power supply 21. The number of MOSFETs connected to each power supply need not be the same.

The operation of the control circuit 24 is similar to that of the control circuit 14a in FIG. 1 described above. During normal operation, current flows from the power supply 21 to the load 22, and the control circuit 24 provides a control voltage V_{C} that is higher than V_{A}+V_{R} to the gate G of each of MOSFETs 23a, 23b, . . . The MOSFETs are turned ON by the gate control voltage, and each behaves like a resistive load.

In the embodiment of FIG. 2, connecting a plurality of MOSFETs in parallel ensures that no single MOSFET will pass greater than its share of the total current. If the junction temperature of one MOSFET rises greater than that of its counterparts, its resistance R_{DSon} will increase, resulting in a self-regulation of its share of the total current. In practice, although reverse body diode MOSFETs typically have a lower amperage limit than ORing diodes, the MOSFETs are typically much less expensive. Connecting a plurality of MOSFETs in parallel as shown in FIG. 2 gives the further benefits of (a) lower resistance and lower voltage drop across the MOSFETs as the number of MOSFETs increases, yielding less loss, less heat, and longer life for the MOSFETs; and (b) an increased power capacity as the number of MOSFETs increases. As an overall result, the MOSFET circuit shown in FIG. 2 is less expensive and more efficient than the ORing diode circuit for a given capacity. In addition, because the gates of the MOSFETs behave like a capacitor and hold their voltages once charged, the burden on the charge pump (not shown in FIG. 2) that provides the drive voltage V_{C} to the comparator 25 is low even when a plurality of MOSFETs are simultaneously controlled.

It will be apparent to those skilled in the art that various modification and variations can be made in the power supply system of the present invention without departing from the spirit or scope of the invention. Thus, it is intended that the present invention cover modifications and variations that come within the scope of the appended claims and their equivalents.

What is claimed is:

1. A circuit adapted to be connected between a load and a plurality of parallel connected power supplies, comprising:
a plurality of metal-oxide-semiconductor field effect transistors (MOSFETs) each having a source connected to a power supply voltage provided by a power supply, a drain connected to the load to provide a load voltage, and a gate; and
a plurality of control circuits each having a first and a second input connected to the source and the drain of one or more MOSFETs, respectively, and an output connected to the gate of the corresponding MOSFETs for applying a control voltage to turn the MOSFETs on and off, the control voltage being generated based on voltage signals at the first and the second input.

2. The circuit of claim 1, wherein each control circuit is connected to one of the plurality of power supply voltages.

3. The circuit of claim 1, wherein one or more MOSFETs are connected to each power supply voltage.

4. The circuit of claim 1, wherein each control circuit includes a comparator having a non-inverting and an inverting input terminal connected to the source and drain of the corresponding MOSFET, respectively, and an output terminal connected to the gate of the corresponding MOSFET.

5. The circuit of claim 4, further comprising one or more voltage sources for providing a drive voltage to each comparator, the drive voltage being higher than or equal to a sum of the corresponding power supply voltage and a threshold gate-to-source voltage of the MOSFETs.

6. The circuit of claim 5, wherein the voltage source is a charge pump connected to the output voltage or the corresponding power supply voltage.

7. The circuit of claim 5, wherein the voltage source is a house keeping source connected to the output voltage or the corresponding power supply voltage.

8. The circuit of claim 1, wherein the control circuits dynamically control voltage drops of the corresponding MOSFETs to provide a substantially equal load balancing among the plurality of power supplies.

9. A method of providing power from a plurality of parallel connected power supplies to a load, comprising:
connecting one or more metal-oxide-semiconductor field effect transistors (MOSFET) between each power supply and the load, wherein a source of each MOSFET is connected to a corresponding power supply and a drain of the MOSFET is connected to the load; and
controlling the conductivity between the source and drain of each MOSFET by generating a control voltage in response to a voltage signal at the source and a voltage signal at the drain of the corresponding MOSFET and applying the control voltage to a gate of the MOSFET to turn the MOSFET on and off.

10. The method of claim 9, wherein the controlling step includes comparing the voltage signal at the source and the voltage signal at the drain of the MOSFET.

11. The method of claim 9, further comprising dynamically controlling a voltage drop of each MOSFET to provide a substantially equal load balancing among the plurality of power supplies.

12. A circuit adapted to be connected between a load and a plurality of parallel connected power supplies, comprising:
a plurality of metal-oxide-semiconductor field effect transistors (MOSFETs) each having a source connected to a power supply voltage provided by a power supply, a drain connected to the load to provide a load voltage, and a gate; and
a plurality of control circuits each connected to a power supply voltage and outputting a high and a low control voltage to the gate of the corresponding MOSFETs connected to the power supply voltage to turn the MOSFETs on and off, the high control voltage being higher than or equal to a sum of the respective power supply voltage and a threshold gate-to-source voltage of the MOSFETs.

13. The circuit of claim 12, wherein each control circuit is connected to one of the plurality of power supply voltages.

14. The circuit of claim 12, wherein one or more MOSFETs are connected to each power supply voltage.

15. The circuit of claim 12, wherein the control circuit includes a comparator having a non-inverting and an inverting input terminal connected to the source and drain of the corresponding MOSFET, respectively, and an output terminal connected to the gate of the MOSFET,

16. The circuit of claim 15, further comprising one or more voltage sources for providing a drive voltage to the comparator, the drive voltage being higher than or equal to a sum of the corresponding power supply voltage and a threshold gate-to-source voltage of the MOSFETs.

17. The circuit of claim 16, wherein the voltage source is a charge pump connected to the output voltage or the corresponding power supply voltage.

18. The circuit of claim 16, wherein the voltage source is a house keeping source connected to the output voltage or the corresponding power supply voltage.

19. The circuit of claim 12, wherein the control circuits dynamically control voltage drops of the corresponding MOSFETs to provide a substantially equal load balancing among the plurality of power supplies.

20. A method of providing power from a plurality of parallel connected power supplies to a load, comprising:
connecting one or more metal-oxide-semiconductor field effect transistors (MOSFET) between each power supply and the load, wherein a source of each MOSFET is connected to a corresponding power supply and a drain of the MOSFET is connected to the load; and
controlling the conductivity between the source and drain of each MOSFET by applying a high and a low control voltage to the gate of the MOSFET to turn the MOSFET on and off, the high control voltage being higher than or equal to a sum of the voltage of the power supply connected to the MOSFET and a threshold gate-to-source voltage of the MOSFET.

21. The method of claim 20, wherein the controlling step includes comparing the voltage signal at the source and the voltage signal at the drain of the MOSFET.

22. The method of claim 20, further comprising dynamically controlling a voltage drop of each MOSFET to provide a substantially equal load balancing among the plurality of power supplies.
